(19) United States
(12) Patent Application Publication
(10) Pub. No.: US 2024/0395451 A1
(43) Pub. Date: Nov. 28, 2024

(54) ELECTRONIC COMPONENT

(71) Applicant: Delta Electronics, Inc., Taoyuan City (TW)

(72) Inventors: Yi-Che Su, Taoyuan City (TW); Ssu-Wei Fu, Taoyuan City (TW); Kun-Te Chen, Taoyuan City (TW); Hsin-Tsung Lai, Taoyuan City (TW); Chun-Ching Yen, Taoyuan City (TW); Fan Liu, Taoyuan City (TW)

(21) Appl. No.: 18/383,416

(22) Filed: Oct. 24, 2023

(30) Foreign Application Priority Data
May 23, 2023 (CN) 202310583232.3

(51) Int. Cl. H01F 27/26; H01F 27/02; H01F 27/30

(52) U.S. Cl. CPC H01F 27/266; H01F 27/02; H01F 27/306

(57) ABSTRACT

An electronic component includes a casing and an electronic element. The casing includes a bottom plate, a backplate, a first protrusion and a second protrusion. The bottom plate has a first surface. The backplate is connected with the bottom plate and perpendicular to the bottom plate. The backplate has a third surface and a fourth surface. The third surface and the fourth surface are opposite to each other. The first protrusion and the second protrusion are extended from the third surface of the backplate toward a direction parallel to the bottom plate, respectively. The electronic element is disposed on the first surface of the bottom plate and adjacent to the third surface of the backplate. The bottom plate, the backplate, the first protrusion and the second protrusion are disposed around the electronic element.

### CROSS-REFERENCE TO RELATED APPLICATION

This application claims priority to China Patent Application No. 202310583232.3 filed on May 23, 2023, the entire contents of which are incorporated herein by reference for all purposes.

### FIELD OF THE INVENTION

The present disclosure relates to an electronic component, and more particularly to an electronic component having at least two protrusions.

### BACKGROUND OF THE INVENTION

The electronic component includes a toroidal magnetic core, a winding and a base. The winding is wounded around the toroidal magnetic core. A section of the winding is located at one side of the toroidal magnetic core, and the other section of the winding is located at the other side of the toroidal magnetic core. The base is disposed on the toroidal magnetic core and located between the two sections of the winding. However, the base of the electronic component disposed between the two sections of the winding is used for disposing the toroidal magnetic core thereon merely. When the electronic component needs to be moved, the base of the electronic component cannot be easily grasped by automatic arms, such as robotic arms. Instead, the base needs to be manually handled to move the electronic component. Consequently, the conventional electronic component has the disadvantages of low convenience and high cost for relocation.

Therefore, there is a need of providing an electronic component to obviate the drawbacks encountered from the prior arts.

### SUMMARY OF THE INVENTION

The present disclosure provides an electronic component. The electronic component includes a first protrusion and a second protrusion. The first protrusion and the second protrusion are extended from a third surface of the backplate toward the direction parallel to the bottom plate or perpendicular to the third surface of the backplate, respectively. Consequently, when the electronic component needs to be moved, the first protrusion and the second protrusion of the electronic component can be directly grasped by automatic arms so as to relocate the electronic component. Consequently, the electronic component of the present disclosure has the advantages of enhanced convenience and low cost for relocation.

In accordance with an aspect of the present disclosure, there is provided an electronic component. The electronic component includes a casing and an electronic element. The casing includes a bottom plate, a backplate, a first protrusion and a second protrusion. The bottom plate has a first surface. One lateral side of the backplate is connected with one lateral side of the bottom plate. The backplate is perpendicular to the bottom plate. The backplate has a third surface and a fourth surface. The third surface and the fourth surface are opposite to each other. The first protrusion is extended from the third surface of the backplate toward a direction parallel to the bottom plate. The second protrusion is extended from the third surface of the backplate toward the direction parallel to the bottom plate. The electronic element is disposed on the first surface of the bottom plate and adjacent to the third surface of the backplate. The bottom plate, the backplate, the first protrusion and the second protrusion are disposed around the electronic element.

In accordance with another aspect of the present disclosure, there is provided an electronic component. The electronic component includes a casing and an electronic element. The casing includes a backplate, a first protrusion and a second protrusion. The backplate has a third surface and a fourth surface. The third surface and the fourth surface are opposite to each other. The first protrusion is extended from the third surface of the backplate toward a direction perpendicular to the third surface of the backplate. The second protrusion is extended from the third surface of the backplate toward the direction perpendicular to the third surface of the backplate. The electronic element is disposed on the third surface of the backplate. The backplate, the first protrusion and the second protrusion are disposed around the electronic element.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating an electronic component according to a first embodiment of the present disclosure;

FIG. 2 is a schematic exploded view illustrating the electronic component of FIG. 1;

FIG. 3 is a schematic view illustrating the electronic component of FIG. 1 and taken along another viewpoint;

FIG. 4 is a schematic view illustrating an electronic component according to a second embodiment of the present disclosure;

FIG. 5 is a schematic exploded view illustrating the electronic component of FIG. 4;

FIG. 6 is a schematic view illustrating the electronic component of FIG. 4 and taken along another viewpoint;

FIG. 7 is a schematic view illustrating an electronic component according to a third embodiment of the present disclosure;

FIG. 8 is a schematic exploded view illustrating the electronic component of FIG. 7;

FIG. 9 is a schematic view illustrating the electronic component of FIG. 7 and taken along another viewpoint;

FIG. 10 is a schematic view illustrating an electronic component according to a fourth embodiment of the present disclosure;

FIG. 11 is a schematic exploded view illustrating the electronic component of FIG. 10;

FIG. 12 is a schematic view illustrating the electronic component of FIG. 10 and taken along another viewpoint;

FIG. 13A is a lateral view illustrating the electronic component of FIG. 10, wherein the bendable portion of the electronic component is not bended;

FIG. 13B is a lateral view illustrating the electronic component of FIG. 10, wherein the bendable portion of the electronic component is bended;

FIG. 14 is a schematic view illustrating an electronic component according to a fifth embodiment of the present disclosure;

FIG. 15 is a schematic exploded view illustrating the electronic component of FIG. 14;

FIG. 16 is a schematic view illustrating the electronic component of FIG. 14 and taken along another viewpoint;

FIG. 17 is a schematic view illustrating an electronic component according to a sixth embodiment of the present disclosure;

FIG. 18 is a schematic exploded view illustrating the electronic component of FIG. 17; and

FIG. 19 is a schematic view illustrating the electronic component of FIG. 17 and taken along another viewpoint.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

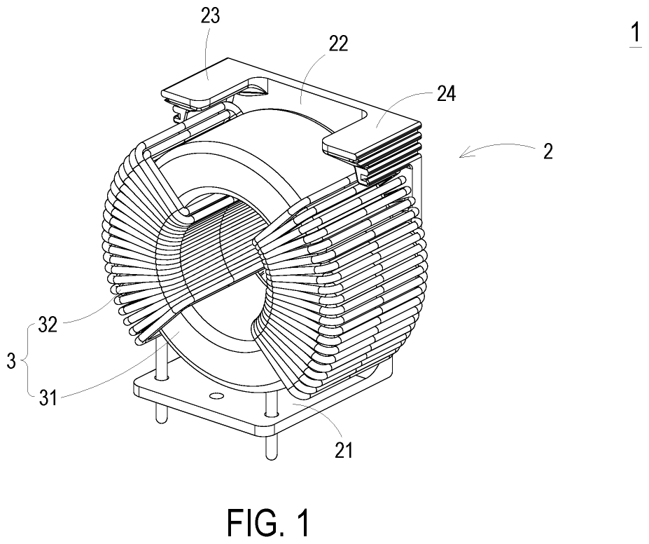

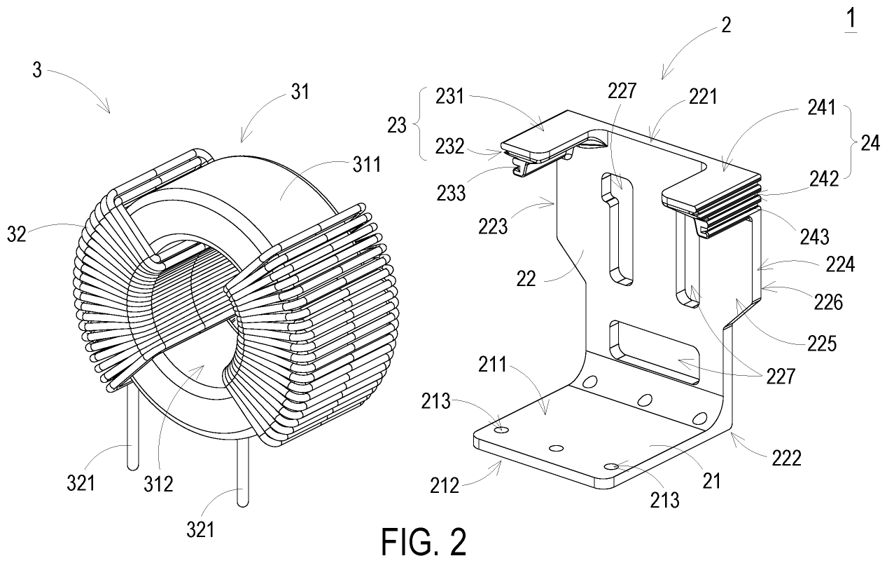

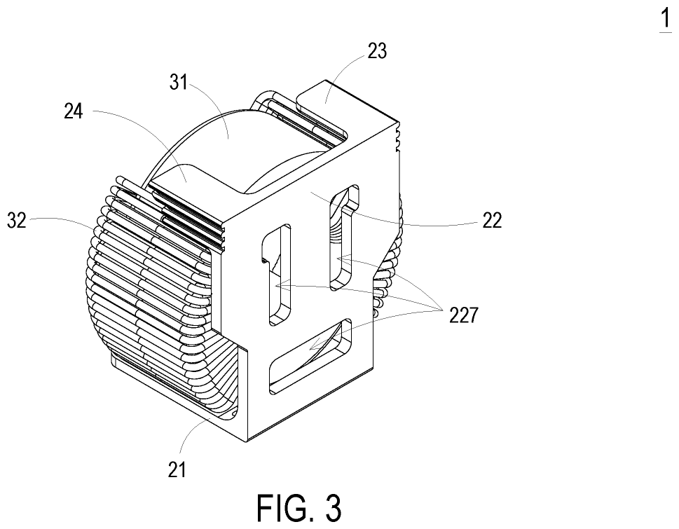

FIG. 1 is a schematic view illustrating an electronic component according to a first embodiment of the present disclosure. FIG. 2 is a schematic exploded view illustrating the electronic component of FIG. 1. FIG. 3 is a schematic view illustrating the electronic component of FIG. 1 and taken along another viewpoint. As shown in FIGS. 1 to 3, the electronic component 1 includes a casing 2 and an electronic element 3. The casing 2 includes a bottom plate 21, a backplate 22, a first protrusion 23 and a second protrusion 24. In this embodiment, the bottom plate 21, the backplate 22, the first protrusion 23 and the second protrusion 24 are integrally formed into one piece.

As shown in FIG. 2, the bottom plate 21 includes a first surface 211 and a second surface 212. The first surface 211 and the second surface 212 of the bottom plate 21 are opposite to each other. The electronic component 1 is disposed on an electronic product (not shown) through the second surface 212 of the bottom plate 21. In this embodiment, the bottom plate 21 includes at least two outlet holes 213 running through the first surface 211 and the second surface 212. The backplate 22 includes a first lateral side 221, a second lateral side 222, a third lateral side 223, a fourth lateral side 224, a third surface 225 and a fourth surface 226. The first lateral side 221 and the second lateral side 222 of the backplate 22 are opposite to each other. The second lateral side 222 of the backplate 22 is connected with one lateral side of the bottom plate 21. The backplate 22 is perpendicular to the bottom plate 21. The third lateral side 223 and the fourth lateral side 224 of the backplate 22 are opposite to each other and located between the first lateral side 221 and the second lateral side 222 of the backplate 22. The third surface 225 and the fourth surface 226 of the backplate 22 are opposite to each other. The third surface 225 and the fourth surface 226 are located between the first lateral side 221 and the second lateral side 222 and located between the third lateral side 223 and the fourth lateral side 224 of the backplate 22.

The first protrusion 23 is extended from the third surface 225 of the backplate 22 toward the direction parallel to the bottom plate 21. The extension direction of the first protrusion 23 is from the fourth surface 226 toward the third surface 225 of the backplate 22. In this embodiment, the first protrusion 23 is formed on the connection between the first lateral side 221 and the third lateral side 223 of the backplate 22. The second protrusion 24 is extended from the third surface 225 of the backplate 22 toward the direction parallel to the bottom plate 21. The extension direction of the second protrusion 24 is from the fourth surface 226 toward the third surface 225 of the backplate 22. In this embodiment, the second protrusion 24 is formed on the connection between the first lateral side 221 and the fourth lateral side 224 of the backplate 22.

Preferably but not exclusively, the electronic element 3 is a magnetic element and includes a toroidal magnetic core 31 and a winding 32. The toroidal magnetic core 31 includes a main body 311 and a hollow portion 312. The hollow portion 312 runs through the center of the main body 311. The winding 32 is wounded around the main body 311 of the toroidal magnetic core 31. At least portion of the winding 32 penetrates the hollow portion 312. The winding 32 includes at least two outlet terminals 321. Each outlet terminal 321 penetrates the corresponding outlet hole 213 of the bottom plate 21 from the first surface 211 to the second surface 212 so that portion of the outlet terminal 321 is protruded from the second surface 212 through the corresponding outlet hole 213. Consequently, the electronic element 3 is vertically disposed on the bottom plate 21 of the casing 2.

From above, the electronic component 1 of the present disclosure includes a first protrusion 23 and a second protrusion 24. The first protrusion 23 and the second protrusion 24 are extended from the third surface 225 of the backplate 22 toward the direction parallel to the bottom plate 21, respectively. Consequently, when the electronic component 1 needs to be moved, the first protrusion 23 and the second protrusion 24 of the electronic component 1 can be directly grasped by automatic arms so as to relocate the electronic component 1. Consequently, the electronic component 1 of the present disclosure has the advantages of enhanced convenience and low cost for relocation.

Please refer to FIG. 2. The first protrusion 23 further includes a fifth surface 231 and a sixth surface 232. The fifth surface 231 of the first protrusion 23 is extended from the first lateral side 221 of the backplate 22 toward the direction parallel to the bottom plate 21. The sixth surface 232 of the first protrusion 23 is extended from the third lateral side 223 of the backplate 22 toward the direction parallel to the bottom plate 21. The second protrusion 24 includes a seventh surface 241 and an eighth surface 242. The seventh surface 241 of the second protrusion 24 is extended from the first lateral side 221 of the backplate 22 toward the direction parallel to the bottom plate 21. The eighth surface 242 of the second protrusion 24 is extended from the fourth lateral side 224 of the backplate 22 toward the direction parallel to the bottom plate 21. In this embodiment, the sixth surface 232 of the first protrusion 23 includes at least one first groove 233 for increasing the contact area of the sixth surface 232. The eighth surface 242 of the second protrusion 24 includes at least one second groove 243 for increasing the contact area of the eighth surface 242. When the electronic component 1 is grasped by automatic arms through the sixth surface 232 of the first protrusion 23 and the eighth surface 242 of the second protrusion 24, the friction coefficient between the automatic arms and the sixth surface 232 is increased by the first groove 233 located on the sixth surface 232, and the friction coefficient between the automatic arms and the eighth surface 242 is increased by the second groove 243 located on the eighth surface 242. Consequently, the stability of the electronic component 1 grasped by automatic arms is increased. In this embodiment, the backplate 22 includes at least one heat dissipation hole 227. For example, the backplate 22 includes three heat dissipation holes 227 running through the third surface 225 and the fourth surface 226 of the backplate 22 for enhancing the heat dissipation of the electronic component 1.

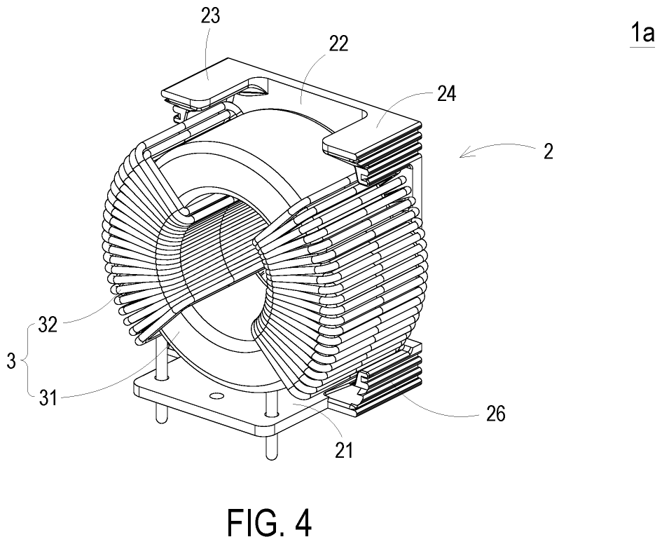

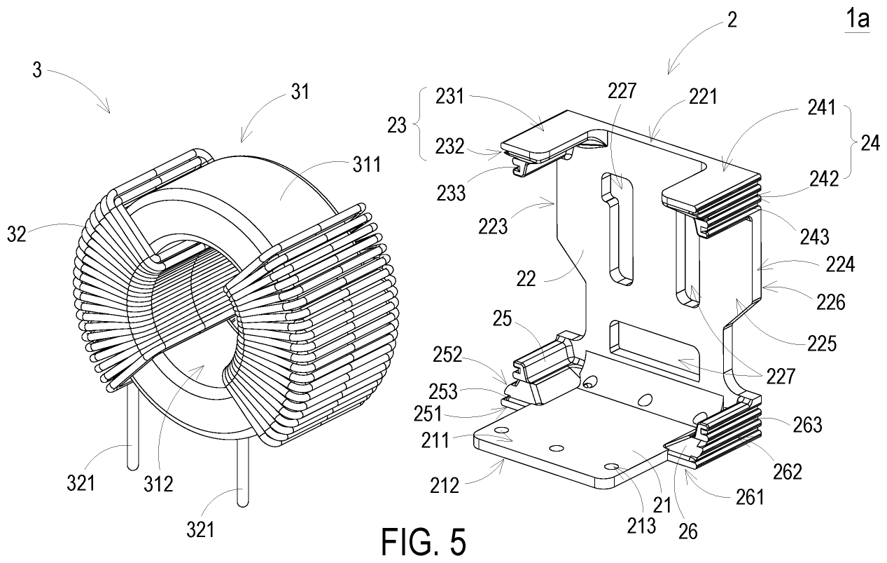

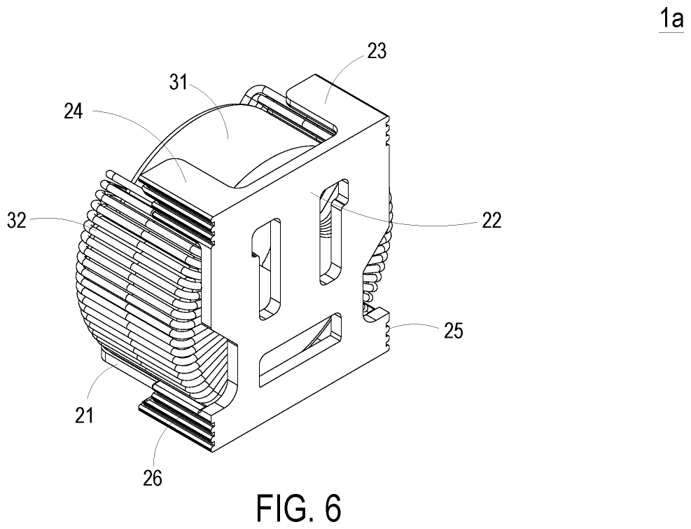

In some embodiments, the number of the protrusion of the electronic component is more than two. FIG. 4 is a schematic view illustrating an electronic component according to a second embodiment of the present disclosure. FIG. 5 is a schematic exploded view illustrating the electronic component of FIG. 4. FIG. 6 is a schematic view illustrating the electronic component of FIG. 4 and taken along another viewpoint. As shown in FIGS. 4 to 6, compared with the electronic component 1 of the first embodiment, the casing 2 of the electronic component la of this embodiment further includes a third protrusion 25 and a fourth protrusion 26. The third protrusion 25 is extended from the third surface 225 of the backplate 22 toward the direction parallel to the bottom plate 21. The extension direction of the third protrusion 25 is from the fourth surface 226 toward the third surface 225 of the backplate 22. The third protrusion 25 is formed on the connection between the second lateral side 222 and the third lateral side 223 of the backplate 22. The third protrusion 25 includes a ninth surface 251 and a tenth surface 252. The ninth surface 251 of the third protrusion 25 is extended from the second lateral side 222 of the backplate 22 toward the direction parallel to the bottom plate 21. The tenth surface 252 of the third protrusion 25 is extended from the third lateral side 223 of the backplate 22 toward the direction parallel to the bottom plate 21.

The fourth protrusion 26 is extended from the third surface 225 of the backplate 22 toward the direction parallel to the bottom plate 21. The extension direction of the fourth protrusion 26 is from the fourth surface 226 toward the third surface 225 of the backplate 22. The fourth protrusion 26 is formed on the connection between the second lateral side 222 and the fourth lateral side 224 of the backplate 22. The fourth protrusion 26 includes an eleventh surface 261 and a twelfth surface 262. The eleventh surface 261 of the fourth protrusion 26 is extended from the second lateral side 222 of the backplate 22 toward the direction parallel to the bottom plate 21. The twelfth surface 262 of the fourth protrusion 26 is extended from the fourth lateral side 224 of the backplate 22 toward the direction parallel to the bottom plate 21.

In this embodiment, the tenth surface 252 of the third protrusion 25 includes at least one third groove 253 for increasing the contact area of the tenth surface 252. The twelfth surface 262 of the fourth protrusion 26 includes at least one fourth groove 263 for increasing the contact area of the twelfth surface 262. The electronic component la can be grasped by automatic arms through the sixth surface 232 of the first protrusion 23 and the eighth surface 242 of the second protrusion 24 or through the tenth surface 252 of the third protrusion 25 and the twelfth surface 262 of the fourth protrusion 26. The friction coefficient between the automatic arms and the tenth surface 252 is increased by the third groove 253 of the tenth surface 252, and the friction coefficient between the automatic arms and the twelfth surface 262 is increased by the fourth groove 263 of the twelfth surface 262. Consequently, the stability of the electronic component 1 grasped by automatic arms is increased. Certainly, the electronic component la can be grasped by automatic arms through the first protrusion 23, the second protrusion 24, the third protrusion 25 and the fourth protrusion 26 at the same time. In some embodiments, the electronic component la can be grasped by automatic arms through the first protrusion 23 and the second protrusion 24 only for relocation, or the electronic component la can be grasped by automatic arms through the third protrusion 25 and the fourth protrusion 26 only for relocation.

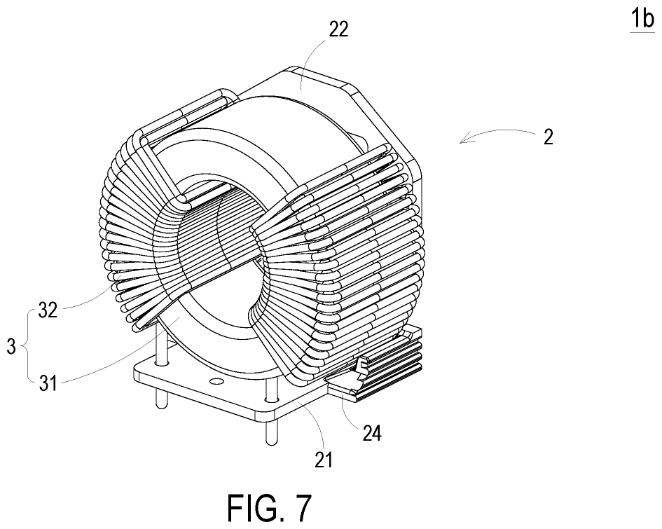

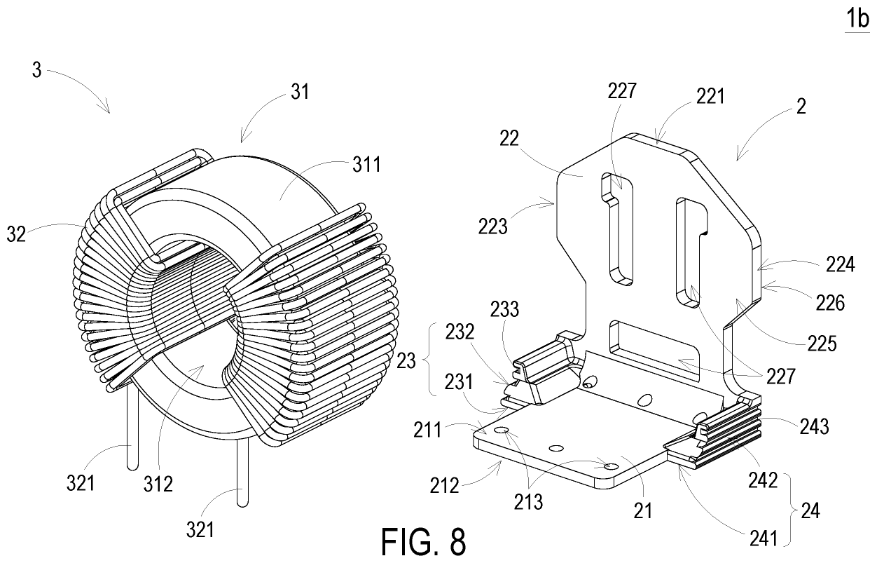

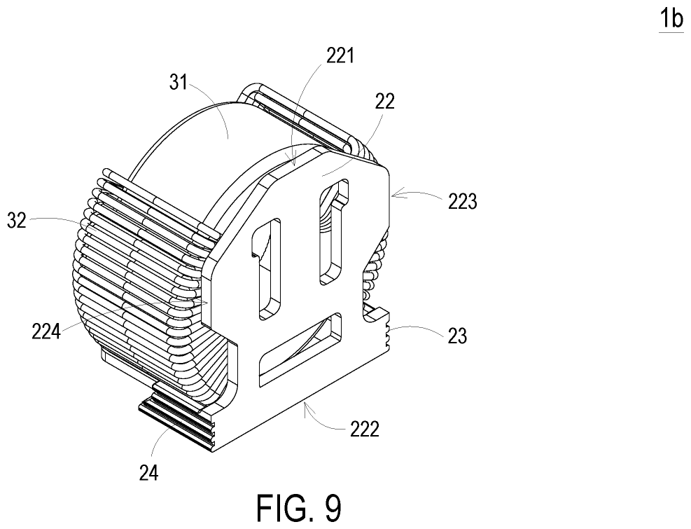

FIG. 7 is a schematic view illustrating an electronic component according to a third embodiment of the present disclosure. FIG. 8 is a schematic exploded view illustrating the electronic component of FIG. 7. FIG. 9 is a schematic view illustrating the electronic component of FIG. 7 and taken along another viewpoint. As shown in FIGS. 7 to 9, comparing with the electronic component 1 of the first embodiment, the first protrusion 23 of the electronic component 1b of this embodiment is formed on the connection between the second lateral side 222 and the third lateral side 223 of the backplate 22. The first protrusion 23 further includes a fifth surface 231 and a sixth surface 232. The fifth surface 231 of the first protrusion 23 is extended from the second lateral side 222 of the backplate 22 toward the direction parallel to the bottom plate 21. The sixth surface 232 of the first protrusion 23 is extended from the third lateral side 223 of the backplate 22 toward the direction parallel to the bottom plate 21. The sixth surface 232 of the first protrusion 23 includes at least one first groove 233 for increasing the contact area of the sixth surface 232.

The second protrusion 24 of the electronic component 1b of this embodiment is formed on the connection between the second lateral side 222 and the fourth lateral side 224 of the backplate 22. The bottom plate 21 is disposed between the first protrusion 23 and the second protrusion 24. The second protrusion 24 includes a seventh surface 241 and an eighth surface 242. The seventh surface 241 of the second protrusion 24 is extended from the second lateral side 222 of the backplate 22 toward the direction parallel to the bottom plate 21. The eighth surface 242 of the second protrusion 24 is extended from the fourth lateral side 224 of the backplate 22 toward the direction parallel to the bottom plate 21. The eighth surface 242 of the second protrusion 24 includes at least one second groove 243 for increasing the contact area of the eighth surface 242.

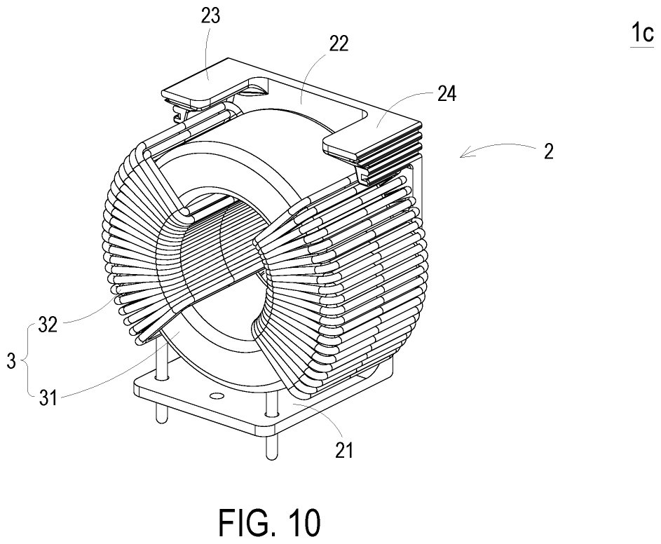

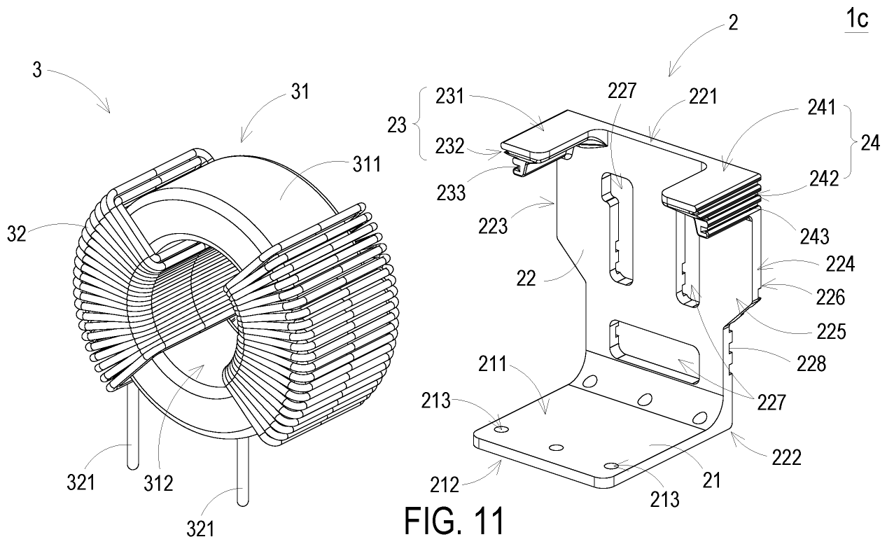

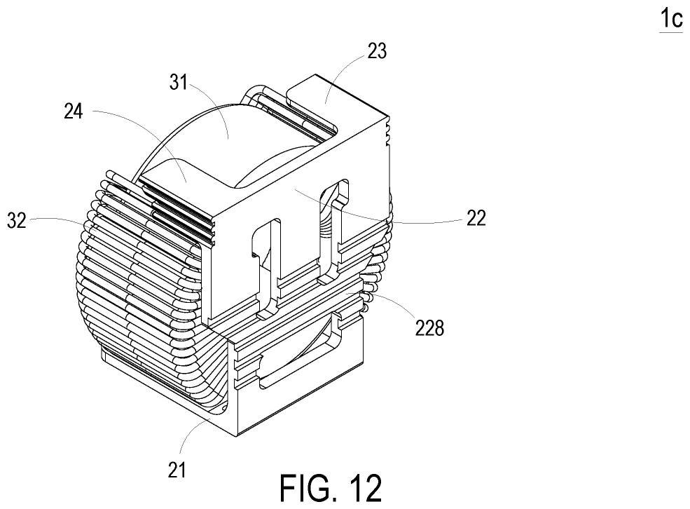

FIG. 10 is a schematic view illustrating an electronic component according to a fourth embodiment of the present disclosure. FIG. 11 is a schematic exploded view illustrating the electronic component of FIG. 10. FIG. 12 is a schematic view illustrating the electronic component of FIG. 10 and taken along another viewpoint. As shown in FIGS. 10 to 12, compared with the electronic component 1 of the first embodiment, the backplate 22 of the electronic component 1c of this embodiment includes a bendable portion 228. The bendable portion 228 is concavely formed on the fourth surface 226 of the backplate 22. Preferably but not exclusively, the bendable portion 228 is made of flexible material. When the electronic element 3 is to be disposed within the casing 2, the backplate 22 is bended at a proper angle by utilizing the flexibility of the bendable portion 228 so that the electronic element 3 can be disposed in the casing 2.

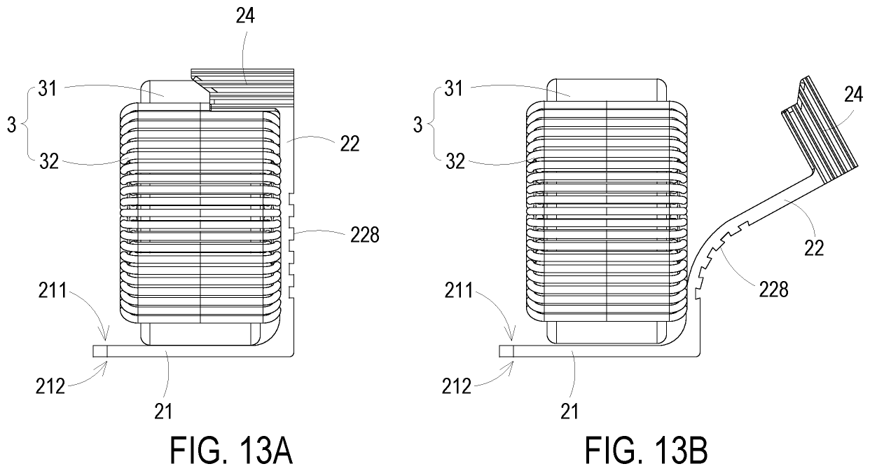

FIG. 13A is a lateral view illustrating the electronic component of FIG. 10, wherein the bendable portion of the electronic component is not bended. FIG. 13B is a lateral view illustrating the electronic component of FIG. 10, wherein the bendable portion of the electronic component is bended. When the electronic element 3 is to be disposed within the casing 2, by utilizing the flexibility of the bendable portion 228 and using the bendable portion 228 as a fulcrum, at least portion of the backplate 22 is bended away from the first surface 211 of the bottom plate 21 in a clockwise direction and bended at a specific angle, as shown in FIG. 13B. When the electronic element 3 is disposed within the casing 2 completely, by using the bend portion 228 as a fulcrum, the bended portion of the backplate 22 is bended toward the first surface 211 of the bottom plate 21 in a counterclockwise direction and recovered to the original position, as shown in FIG. 13A.

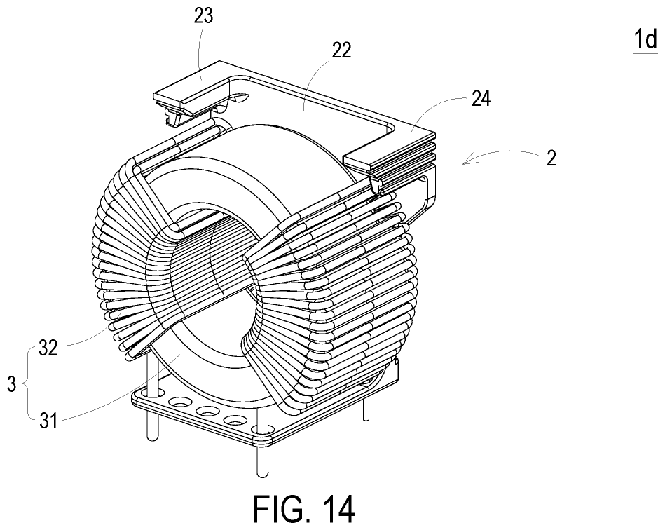

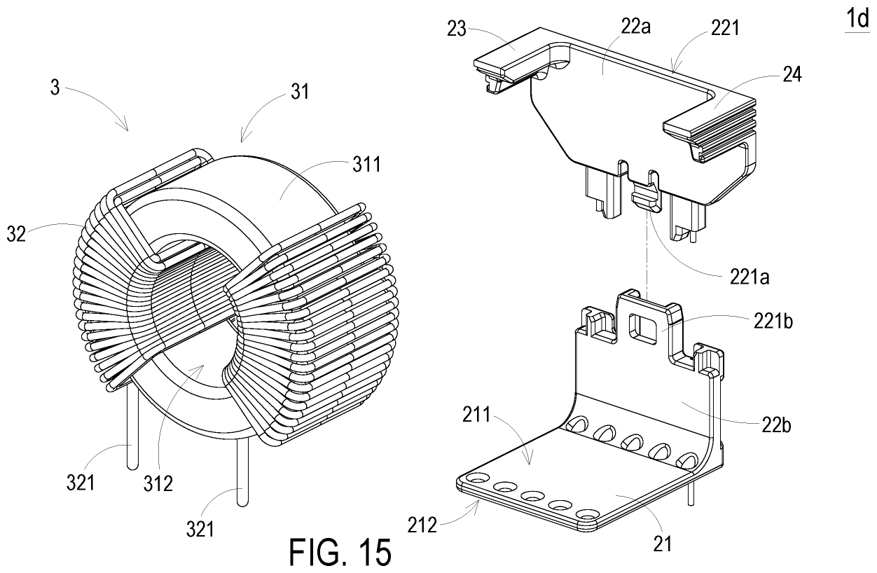

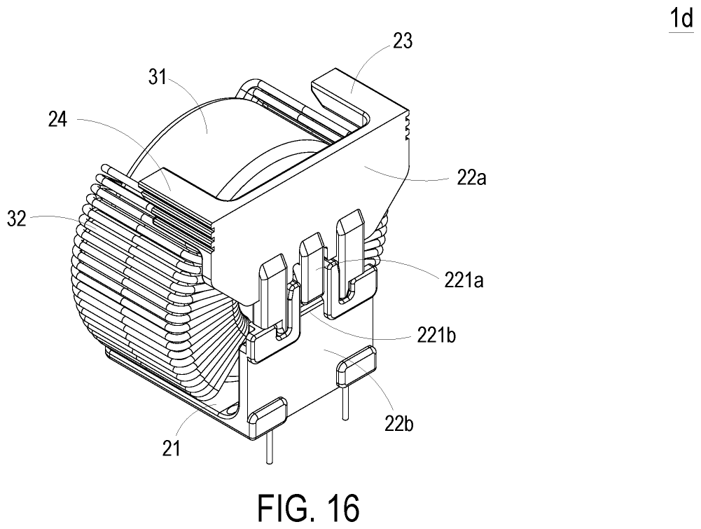

FIG. 14 is a schematic view illustrating an electronic component according to a fifth embodiment of the present disclosure. FIG. 15 is a schematic exploded view illustrating the electronic component of FIG. 14. FIG. 16 is a schematic view illustrating the electronic component of FIG. 14 and taken along another viewpoint. As shown in FIGS. 14 to 16, compared with the electronic component 1 of the first embodiment, the backplate 22 of the electronic component 1d of this embodiment is a two-pieces structure and includes a first sub backplate 22a and a second sub backplate 22b. The first sub backplate 22a, the first protrusion 23 and the second protrusion 24 are integrally formed into one piece. The first sub backplate 22a includes a first engaging portion 221a away from the first lateral side 221 of the backplate 22. The second sub backplate 22b and the bottom plate 21 are integrally formed into one piece. The second sub backplate 22b includes a second engaging portion 221b away from the second lateral side 222 of the backplate 22 and the bottom plate 21. The second engaging portion 221b and the first engaging portion 221a are aligned to each other and engaged with each other so that the first sub backplate 22a and the second sub backplate 22b are connected with each other. In an embodiment, the second engaging portion 221b and the first engaging portion 221a are engaged with each other by utilizing clasping or hooking, but not limited thereto.

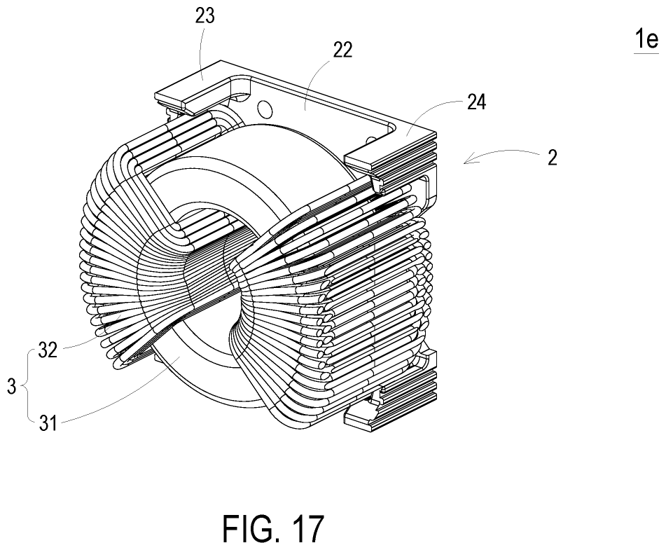

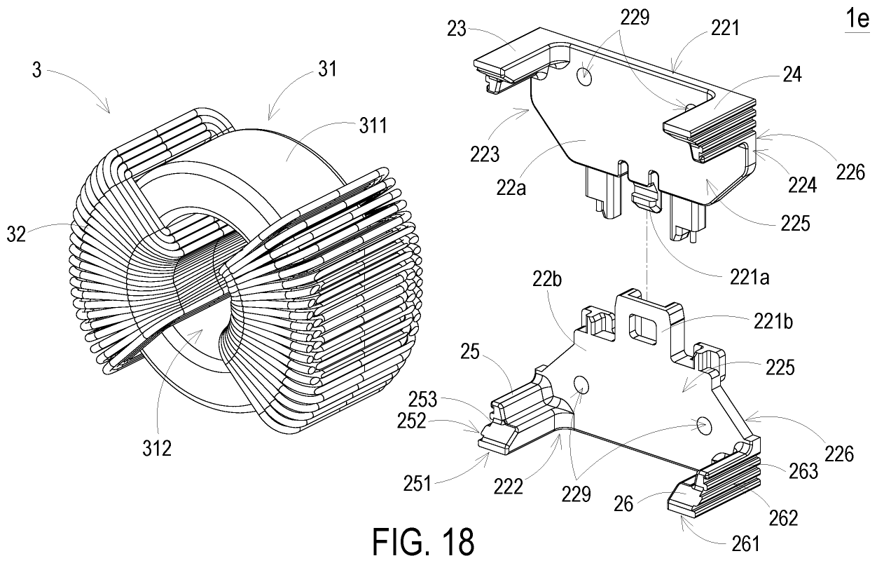

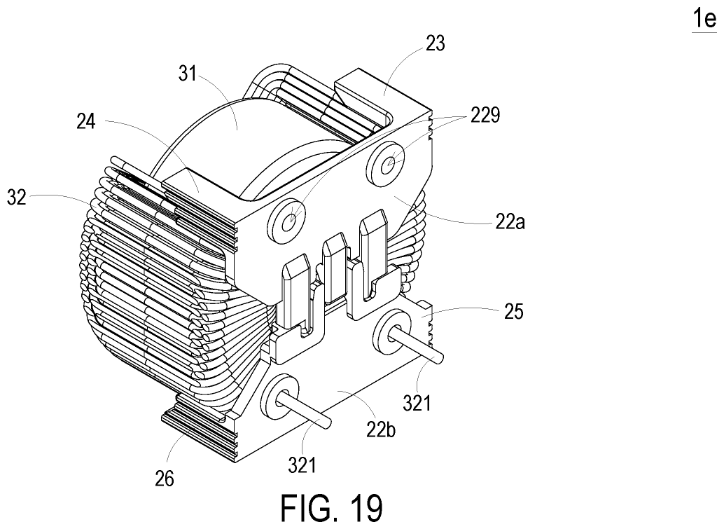

FIG. 17 is a schematic view illustrating an electronic component according to a sixth embodiment of the present disclosure. FIG. 18 is a schematic exploded view illustrating the electronic component of FIG. 17. FIG. 19 is a schematic view illustrating the electronic component of FIG. 17 and taken along another viewpoint. As shown in FIGS. 17 to 19, compared with the electronic element of electronic components of the above embodiments vertically disposed on the bottom plate of the casing, the electronic element 3 of the electronic component le of this embodiment is horizontally disposed on the backplate 22 of the casing 2. In this embodiment, preferably but not exclusively, the bottom plate of the casing is omitted. The installing method of the electronic element 3 of the electronic component le of this embodiment is described below. The backplate 22 of the casing 2 of this embodiment includes at least two outlet holes 229. For example, the backplate 22 includes four outlet holes 229. Two of the four outlet holes 229 are disposed on the first sub backplate 22a of the backplate 22. The other two of the four outlet holes 229 are disposed on the second sub backplate 22b of the backplate 22. Two outlet terminals 321 of the winding 32 penetrate the corresponding outlet holes 229 of the second sub backplate 22b of the backplate 22, respectively. Consequently, the electronic element 3 is horizontally disposed on the casing 2. Certainly, in some embodiments, two outlet terminals 321 of the winding 32 penetrates the corresponding outlet holes 229 of the first sub backplate 22a of the backplate 22, respectively.

The casing 2 of the electronic component 1e of this embodiment further includes a third protrusion 25 and a fourth protrusion 26. The third protrusion 25 is extended from the third surface 225 of the backplate 22 toward the direction perpendicular to the third surface 225 of the backplate 22. The extension direction of the third protrusion 25 is from the fourth surface 226 toward the third surface 225 of the backplate 22. The third protrusion 25 is formed on the connection between the second lateral side 222 and the third lateral side 223 of the backplate 22. The third protrusion 25 includes a ninth surface 251 and a tenth surface 252. The ninth surface 251 of the third protrusion 25 is extended from the second lateral side 222 of the backplate 22 toward the direction perpendicular to the third surface 225 of the backplate 22. The tenth surface 252 of the third protrusion 25 is extended from the third lateral side 223 of the backplate 22 toward the direction perpendicular to the third surface 225 of the backplate 22. The fourth protrusion 26 is extended from the third surface 225 of the backplate 22 toward the direction perpendicular to the third surface 225 of the backplate 22. The extension direction of the fourth protrusion 26 is from the fourth surface 226 toward the third surface 225 of the backplate 22. The fourth protrusion 26 is formed on the connection between the second lateral side 222 and the fourth lateral side 224 of the backplate 22. The fourth protrusion 26 includes an eleventh surface 261 and a twelfth surface 262. The eleventh surface 261 of the fourth protrusion 26 is extended from the second lateral side 222 of the backplate 22 toward the direction perpendicular to the third surface 225 of the backplate 22. The twelfth surface 262 of the fourth protrusion 26 is extended from the fourth lateral side 224 of the backplate 22 toward the direction perpendicular to the third surface 225 of the backplate 22. In this embodiment, the tenth surface 252 of the third protrusion 25 includes at least one third groove 253 for increasing the contact area of the tenth surface 252. The twelfth surface 262 of the fourth protrusion 26 includes at least one fourth groove 263 for increasing the contact area of the twelfth surface 262.

As mentioned above, the electronic component of the present disclosure includes a first protrusion and a second protrusion. The first protrusion and the second protrusion are extended from the surface of the backplate toward the direction parallel to the bottom plate or perpendicular to the third surface of the backplate, respectively. Consequently, when the electronic component needs to be moved, the first protrusion and the second protrusion of the electronic component can be directly grasped by automatic arms so as to relocate the electronic component. Consequently, the electronic component of the present disclosure has the advantages of enhanced convenience and low cost for relocation.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic component, comprising:
a casing, comprising:
a bottom plate having a first surface;
a backplate, wherein one lateral side of the backplate is connected with one lateral side of the bottom plate, the backplate is perpendicular to the bottom plate, the backplate has a third surface and a fourth surface, and the third surface and the fourth surface are opposite to each other;
a first protrusion extended from the third surface of the backplate toward a direction parallel to the bottom plate; and
a second protrusion extended from the third surface of the backplate toward the direction parallel to the bottom plate; and
an electronic element disposed on the first surface of the bottom plate and adjacent to the third surface of the backplate, wherein the bottom plate, the backplate, the first protrusion and the second protrusion are disposed around the electronic element.

2. The electronic component according to claim 1, wherein the bottom plate has a second surface opposite to the first surface, the backplate comprises a first lateral side, a second lateral side, a third lateral side and a fourth lateral side, the first lateral side and the second lateral side are opposite to each other, and the third lateral side and the fourth lateral side are opposite to each other, wherein the bottom plate is connected with the second lateral side of the backplate, the first protrusion is formed on a connection between the first lateral side and the third lateral side, and the second protrusion is formed on a connection between the first lateral side and the fourth lateral side.

3. The electronic component according to claim 2, wherein the first protrusion comprises a fifth surface and a sixth surface, the fifth surface is extended from the first lateral side of the backplate toward the direction parallel to the bottom plate, the sixth surface is extended from the third lateral side of the backplate toward the direction parallel to the bottom plate, wherein the second protrusion comprises a seventh surface and an eighth surface, the seventh surface is extended from the first lateral side of the backplate toward the direction parallel to the bottom plate, and the eighth surface is extended from the fourth lateral side of the backplate toward the direction parallel to the bottom plate.

4. The electronic component according to claim 3, wherein the sixth surface comprises at least one first groove, and the eighth surface comprises at least one second groove.

5. The electronic component according to claim 2, wherein the casing comprises a third protrusion and a fourth protrusion, the third protrusion is extended from the third surface of the backplate toward the direction parallel to the bottom plate, the third protrusion is formed on a connection between the second lateral side and the third lateral side, the fourth protrusion is extended from the third surface of the backplate toward the direction parallel to the bottom plate, the fourth protrusion is formed on a connection between the second lateral side and the fourth lateral side, and the bottom plate is disposed between the third protrusion and the fourth protrusion.

6. The electronic component according to claim 5, wherein the third protrusion comprises a ninth surface and a tenth surface, the ninth surface is extended from the second lateral side of the backplate toward the direction parallel to the bottom plate, the tenth surface is extended from the third lateral side of the backplate toward the direction parallel to the bottom plate, the fourth protrusion comprises an eleventh surface and a twelfth surface, the eleventh surface is extended from the second lateral side of the backplate toward the direction parallel to the bottom plate, and the twelfth surface is extended from the fourth lateral side of the backplate toward the direction parallel to the bottom plate.

7. The electronic component according to claim 6, wherein the tenth surface comprises at least one third groove, and the twelfth surface comprises at least one fourth groove.

8. The electronic component according to claim 1, wherein the bottom plate has a second surface opposite to the first surface, the backplate comprises a first lateral side, a second lateral side, a third lateral side and a fourth lateral side, the first lateral side and the second lateral side are opposite to each other, the third lateral side and the fourth lateral side are opposite to each other, wherein the bottom plate is connected with the second lateral side of the backplate, the first protrusion is formed on a connection between the second lateral side and the third lateral side, the second protrusion is formed on a connection between the second lateral side and the fourth lateral side, and the bottom plate is disposed between the first protrusion and the second protrusion.

9. The electronic component according to claim 8, wherein the first protrusion comprises a fifth surface and a sixth surface, the fifth surface is extended from the second lateral side of the backplate toward the direction parallel to the bottom plate, the sixth surface is extended from the third lateral side of the backplate toward the direction parallel to the bottom plate, wherein the second protrusion comprises a seventh surface and an eighth surface, the seventh surface is extended from the second lateral side of the backplate toward the direction parallel to the bottom plate, and the eighth surface is extended from the fourth lateral side of the backplate toward the direction parallel to the bottom plate.

10. The electronic component according to claim 1, wherein the backplate comprises at least one heat dissipation hole running through the third surface and the fourth surface of the backplate.

11. The electronic component according to claim 1, wherein the electronic element comprises a toroidal magnetic core and a winding, the toroidal magnetic core comprises a main body and a hollow portion, and the winding is wounded around the main body of the toroidal magnetic core, wherein at least portion of the winding penetrates the hollow portion, the winding comprises at least one outlet terminal, the bottom plate comprises at least one outlet hole, and the at least one outlet terminal penetrates the at least one outlet hole so as to dispose the electronic element on the bottom plate of the casing.

12. The electronic component according to claim 1, wherein the backplate, the bottom plate, the first protrusion and the second protrusion are integrally formed into one piece.

13. The electronic component according to claim 1, wherein the backplate comprises a bendable portion concavely formed on the fourth surface of the backplate.

14. The electronic component according to claim 1, wherein the backplate comprises a first sub backplate and a second sub backplate, wherein the first sub backplate, the first protrusion and the second protrusion are integrally formed into one piece, and the first protrusion comprises a first engaging portion away from the first lateral side of the backplate, wherein the second sub backplate and the bottom plate are integrally formed into one piece, the second sub backplate comprises a second engaging portion away from the bottom plate, and the second engaging portion and the first engaging portion are aligned to each other and engaged with each other.

15. An electronic component, comprising:
a casing, comprising:
a backplate having a third surface and a fourth surface, and the third surface and the fourth surface are opposite to each other;
a first protrusion extended from the third surface of the backplate toward a direction perpendicular to the third surface of the backplate; and
a second protrusion extended from the third surface of the backplate toward the direction perpendicular to the third surface of the backplate; and
an electronic element disposed on the third surface of the backplate, wherein the backplate, the first protrusion and the second protrusion are disposed around the electronic element.

16. The electronic component according to claim 15, wherein the electronic element comprises a toroidal magnetic core and a winding, the toroidal magnetic core comprises a main body and a hollow portion, and the winding is wounded around the main body of the toroidal magnetic core, wherein at least portion of the winding penetrates the hollow portion, the winding comprises at least one outlet terminal, the backplate comprises at least one outlet hole, the at least one outlet terminal penetrates the at least one outlet hole so as to dispose the electronic element on the backplate of the casing.
